(19) United States
(12) Patent Application Publication
(10) Pub. No.: US 2011/0102144 A1
(43) Pub. Date: May 5, 2011

(54) Information display system and management device

(76) Inventors: Shigetaka Okina, Chiba-shi (JP); Koichi Moriya, Chiba-shi (JP); Yasuyuki Mitsuoka, Chiba-shi (JP); Takeshi Uchiyama, Chiba-shi (JP); Yuji Akaike, Chiba-shi (JP); Osamu Fukasawa, Tokyo (JP); Yoshihiko Ikeda, Tokyo (JP)

(21) Appl. No.: 12/925,693

(22) Filed: Oct. 27, 2010

(30) Foreign Application Priority Data
Oct. 30, 2009 (JP) 2009-249638

(51) Int. Cl. G06F 7/02

(52) U.S. Cl. 340/5.91

(57) ABSTRACT

An ESL server (3) includes a management-device storage unit for storing information indicating a position at which a second electronic shelf label terminal (1) is installed, a management-device reception unit for receiving information transmitted from a transmission unit of a handy terminal (5), and a management-device control unit for identifying a position at which a first electronic shelf label terminal (1) is installed based on information for uniquely identifying the first electronic shelf label terminal (1), information for uniquely identifying the second electronic shelf label terminal (1), information indicating relative position between the position at which the second electronic shelf label terminal (1) is installed and the position at which the first electronic shelf label terminal (1) is installed, and the information indicating the position at which the second electronic shelf label terminal (1) is installed.

### BACKGROUND OF THE INVENTION

1. Field of the Invention

The present invention relates to an information display system and a management device.

2. Description of the Related Art

There is known a shelf management system in which, at a time of reading a product code displayed at a display position of a product, a handy terminal outputs an ultrasonic wave or the like, and a sensor located in the vicinity of a product shelf detects the ultrasonic wave or the like, to thereby acquire a shelf address (for example, see JP 2004-258976 A).

Further, there is known a method in which a store fixture ID code is attached in advance to a store fixture installed in a store, and a handy terminal reads the store fixture ID code and a product code in a predetermined order, to thereby identify a position of a product based on the order of the reading (for example, see JP 3-123992 A).

However, the technology described in JP 2004-258976 A has a problem in that a large-scale device is required. Further, considering the fact that the store fixture ID code needs to be attached in advance to the store fixture installed in the store, the technology described in JP 3-123992 A has a problem in that it is difficult to perform such operation that deals with an actual situation of a given store, such as changing the configuration of the store fixtures.

### SUMMARY OF THE INVENTION

In view of the above-mentioned problems, the present invention has been made, and therefore has an object to provide an information display system and a management device, which are capable of identifying a position at which an information display device is installed regardless of a configuration of a place where the information display device is installed.

According to the present invention, there is provided an information display system including: a first information display device; a second information display device; a management device; and a handy terminal, in which: the handy terminal includes: an input unit for receiving an input of information indicating relative position between a position at which the second information display device is installed and a position at which the first information display device is installed, the second information display device serving as a reference for identifying the position at which the first information display device is installed; and a transmission unit for transmitting, to the management device, information for uniquely identifying the second information display device, information for uniquely identifying the first information display device, and the information indicating the relative position between the position at which the second information display device is installed and the position at which the first information display device is installed; and the management device includes: a management-device storage unit for storing information indicating the position at which the second information display device is installed; a management-device reception unit for receiving pieces of the information transmitted from the transmission unit of the handy terminal; and a management-device control unit for identifying the position at which the first information display device is installed based on the information for uniquely identifying the first information display device, the information for uniquely identifying the second information display device, the information indicating the relative position between the position at which the second information display device is installed and the position at which the first information display device is installed, and the information indicating the position at which the second information display device is installed.

Further, in the information display system according to the present invention, the input unit receives an input of information indicating the position of the second information display device, the transmission unit transmits, to the management device, the information indicating the position of the second information display device, and the management-device storage unit stores the information indicating the position of the second information display device, which is transmitted from the transmission unit.

Further, in the information display system according to the present invention, the management-device control unit causes the second information display device to display a barcode indicating information on the position at which the second information display device is installed.

Further, according to the present invention, there is provided a management device included in an information display system including: a first information display device; a second information display device; and a handy terminal, the management device including: a management-device storage unit for storing information indicating a position at which the second information display device is installed, the second information display device serving as a reference for identifying a position at which the first information display device is installed; a management-device reception unit for receiving information for uniquely identifying the second information display device, information for uniquely identifying the first information display device, and information indicating relative position between the position at which the second information display device is installed and the position at which the first information display device is installed; and a management-device control unit for identifying the position at which the first information display device is installed based on the information for uniquely identifying the first information display device, the information for uniquely identifying the second information display device, the information indicating the relative position between the position at which the second information display device is installed and the position at which the first information display device is installed, and the information indicating the position at which the second information display device is installed.

Further, in the management device according to the present invention, the management-device control unit causes the second information display device to display a barcode indicating information on the position at which the second information display device is installed.

Further, in the information display system according to the present invention, the first information display device and the second information display device each includes an electronic shelf label terminal.

According to the present invention, a position at which an information display device is installed may be identified regardless of a configuration of a place where the information display device is installed.

### BRIEF DESCRIPTION OF THE DRAWINGS

In the accompanying drawings:

FIG. 1 is a block diagram illustrating a configuration of a retail store system including an electronic shelf label system according to a first embodiment of the present invention;

FIG. 2 is a block diagram illustrating a configuration of an electronic shelf label terminal according to the first embodiment of the present invention;

FIG. 3 is a block diagram illustrating a configuration of an electronic shelf label (ESL) server according to the first embodiment of the present invention;

FIG. 4 is a block diagram illustrating a configuration of a handy terminal according to the first embodiment of the present invention;

FIG. 5 is a schematic diagram illustrating outer appearances of shelves on which the electronic shelf label terminals are installed according to the first embodiment of the present invention;

FIG. 6 is a schematic diagram illustrating a data structure of management information stored in a management-device storage unit of the ESL server according to the first embodiment of the present invention;

FIG. 7 is a schematic diagram illustrating a data structure of the management information stored in the management-device storage unit of the ESL server according to the first embodiment of the present invention;

FIG. 8 is a schematic diagram illustrating a data structure of product information stored in a point of sales (POS) server according to the first embodiment of the present invention;

FIG. 9 is a schematic diagram for a case where nothing is displayed on a display unit of the electronic shelf label terminal according to the first embodiment of the present invention;

FIG. 10 is a schematic diagram illustrating a reference-shelf-label notification screen displayed on the electronic shelf label terminal serving as a reference shelf label according to the first embodiment of the present invention;

FIG. 11 is a schematic diagram illustrating a reference-shelf-label product-information display screen displayed on the electronic shelf label terminal serving as the reference shelf label according to the first embodiment of the present invention;

FIG. 12 is a schematic diagram illustrating a product-information display screen displayed on the electronic shelf label terminal according to the first embodiment of the present invention;

FIG. 13 is a flow chart illustrating operation procedures of the ESL server according to the first embodiment of the present invention;

FIG. 14 is a flow chart illustrating operation procedures of the ESL server according to the first embodiment of the present invention;

FIG. 15 is a flow chart illustrating operation procedures of the ESL server according to a second embodiment of the present invention;

FIG. 16 is a schematic diagram illustrating a data structure of a management information database stored in the management-device storage unit of the ESL server according to a third embodiment of the present invention;

FIG. 17 is a schematic diagram illustrating a position-information-barcode display screen displayed on the electronic shelf label terminal according to the third embodiment of the present invention;

FIG. 18 is a flow chart illustrating operation procedures of the ESL server according to the third embodiment of the present invention;

FIG. 19 is a flow chart illustrating procedures executed when the electronic shelf label terminals are arranged in the shelves according to the third embodiment of the present invention;

FIG. 20 is a flow chart illustrating task procedures executed by an operator when position information and product information are stored in association with information on the electronic shelf label terminal stored in the management information database according to the third embodiment of the present invention;

FIG. 21 is a flow chart illustrating operation procedures executed by the handy terminal when the position information and the product information are stored in association with the information on the electronic shelf label terminal stored in the management information database according to the third embodiment of the present invention;

FIG. 22 is a flow chart illustrating operation procedures executed by the ESL server when the position information and the product information are stored in association with the information on the electronic shelf label terminal stored in the management information database according to the third embodiment of the present invention;

FIG. 23 is a flow chart illustrating operation procedures executed by the handy terminal when information displayed on the electronic shelf label terminal is to be changed according to the third embodiment of the present invention;

FIG. 24 is a flow chart illustrating operation procedures executed by the ESL server when the information displayed on the electronic shelf label terminal is to be changed according to the third embodiment of the present invention; and

FIG. 25 is an external view illustrating outer appearances of shelves on which large-size electronic shelf label terminals are installed.

### DETAILED DESCRIPTION OF THE PREFERRED EMBODIMENTS

### First Embodiment

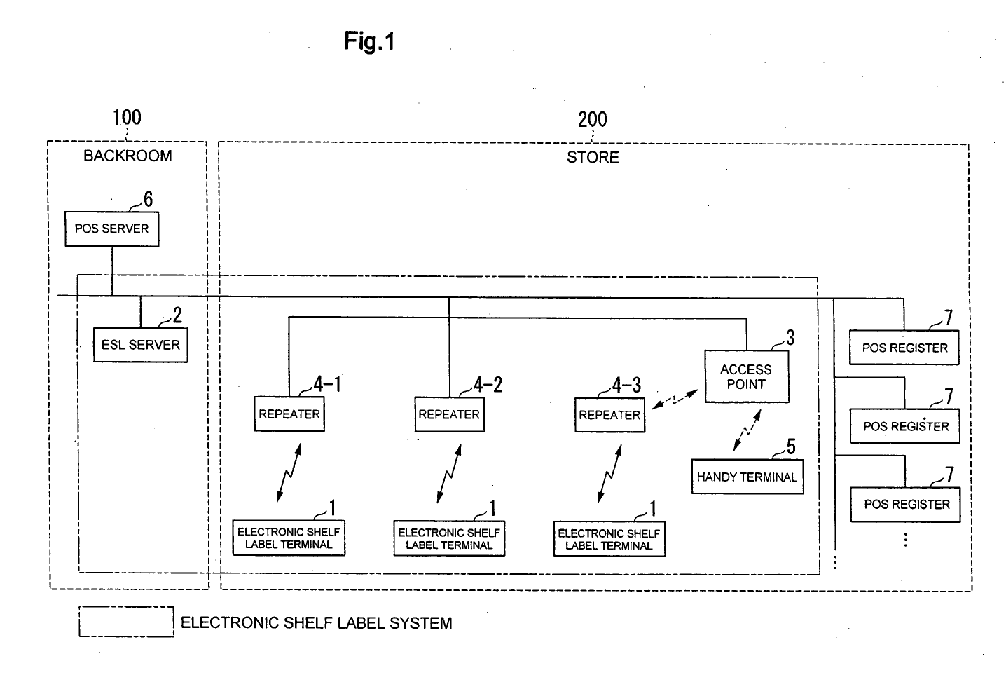

Hereinafter, description is given of a first embodiment of the present invention with reference to the drawings. FIG. 1 is a block diagram illustrating a configuration of a retail store system including an electronic shelf label system according to this embodiment. In the example illustrated in FIG. 1, the retail store system includes the electronic shelf label system (information display system), a point of sales (POS) server 6, and POS registers 7. Further, the electronic shelf label system includes electronic shelf label terminals 1 (information display devices), an ESL server 2 (management device), an access point 3, repeaters 4-1 to 4-3, and a handy terminal 5.

It should be noted that, in the example illustrated in FIG. 1, the electronic shelf label system includes three electronic shelf label terminals 1, three repeaters 4-1 to 4-3, and one handy terminal 5, but the electronic shelf label system may include more electronic shelf label terminals 1, repeaters 4-1 to 4-3, and handy terminals 5. Further, it goes without saying that fewer electronic shelf label terminals 1 and repeaters 4-1 to 4-3 may be included in the electronic shelf label system, compared with the example illustrated in FIG. 1.

The ESL server 2 and the POS server 6 are installed in a backroom 100. The electronic shelf label terminals 1, the access point 3, the repeaters 4-1 to 4-3, and the POS registers 7 are installed in a store 200.

The ESL server 2 is connected to the access point 3, the repeaters 4-1 and 4-2, the POS server 6, and the POS registers 7 through a wired network, and is capable of performing data communication with those components. Further, the access point 3 is connected to the repeater 4-3 and the handy terminal 5 through a wireless network, such as a wireless LAN, and is capable of performing data communication with those components. Further, the electronic shelf label terminals 1 are connected to the repeaters 4-1 to 4-3 through a wireless network using a near field communication scheme (for example, IEEE 802.15.4), and are capable of performing data communication with those components. With this configuration, the electronic shelf label terminals 1 and the ESL server 2 are capable of performing data communication with each other. Further, the ESL server 2 and the handy terminal 5 are capable of performing data communication with each other. It should be noted that, by using the near field wireless scheme for the wireless network between the electronic shelf label terminals 1 and the repeaters 4-1 to 4-3, the electronic shelf label terminals 1 may be downsized, and battery lives thereof may be extended. In addition, communication rates between the electronic shelf label terminals 1 and the repeaters 4-1 to 4-3 may be made higher.

The electronic shelf label terminal 1 displays a price, a description, etc. of a product. The ESL server 2 manages the electronic shelf label terminals 1. The access point 3 and the repeaters 4-1 to 4-3 relay data communication. The handy terminal 5 receives information to be input to the ESL server 2, and then transmits the information to the ESL server 2. The POS server 6 manages information on products, sales information, and the like. The POS register 7 performs checkout processing for a product that a customer intends to purchase.

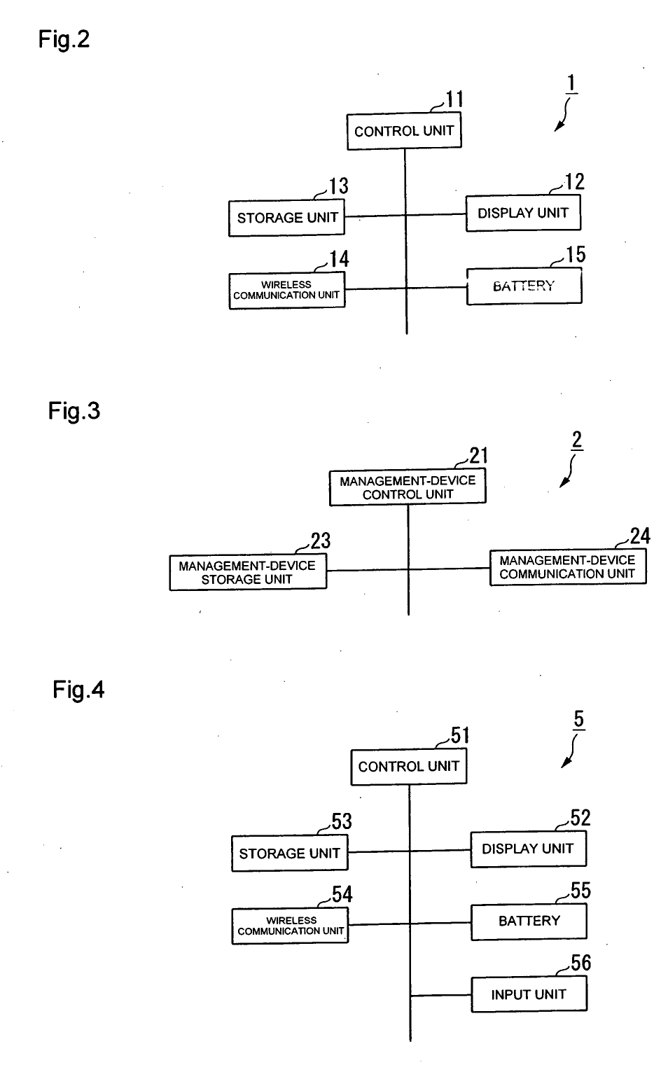

Next, description is given of a configuration of the electronic shelf label terminal 1. FIG. 2 is a block diagram illustrating the configuration of the electronic shelf label terminal 1 according to this embodiment. In the example illustrated in FIG. 2, the electronic shelf label terminal 1 includes a control unit 11, a display unit 12, a storage unit 13, a wireless communication unit 14, and a battery 15.

The control unit 11 controls the units included in the electronic shelf label terminal 1. The display unit 12 is, for example, a liquid crystal display device, and displays a name, a price, etc. of a product. The storage unit 13 temporarily stores data to be used by the units of the electronic shelf label terminal 1 in the course of processing thereof. The wireless communication unit 14 transmits/receives data to/from the ESL server 2 via the repeaters 4-1 to 4-3. The battery 15 supplies power to each of the units included in the electronic shelf label terminal 1.

Next, description is given of a configuration of the ESL server 2. FIG. 3 is a block diagram illustrating the configuration of the ESL server 2 according to this embodiment. In the example illustrated in FIG. 3, the ESL server 2 includes a management-device control unit 21, a management-device storage unit 23, and a management-device communication unit 24 (management-device reception unit).

The management-device control unit 21 controls the units included in the ESL server 2. The management-device storage unit stores a management information database. The management information database is described later. The management-device communication unit 24 transmits/receives data to/from the electronic shelf label terminal 1 and the handy terminal 5 via the access point 3 and the repeaters 4-1 to 4-3.

Next, description is given of a configuration of the handy terminal 5. FIG. 4 is a block diagram illustrating the configuration of the handy terminal 5 according to this embodiment. In the example illustrated in FIG. 4, the handy terminal 5 includes a control unit 51, a display unit 52, a storage unit 53, a wireless communication unit 54 (transmission unit), a battery 55, and an input unit 56.

The control unit 51 controls the units included in the handy terminal 5. The display unit 52 is, for example, a liquid crystal display device, and displays information that is received by the input unit 56. The storage unit 53 temporarily stores data to be used by the units of the handy terminal 5 in the course of processing thereof. The wireless communication unit 54 transmits/receives data to/from the ESL server 2 via the access point 3. The battery 55 supplies power to each of the units included in the handy terminal 5. The input unit 56 includes a barcode reader, an input button, and the like, and receives information to be input to the ESL server 2.

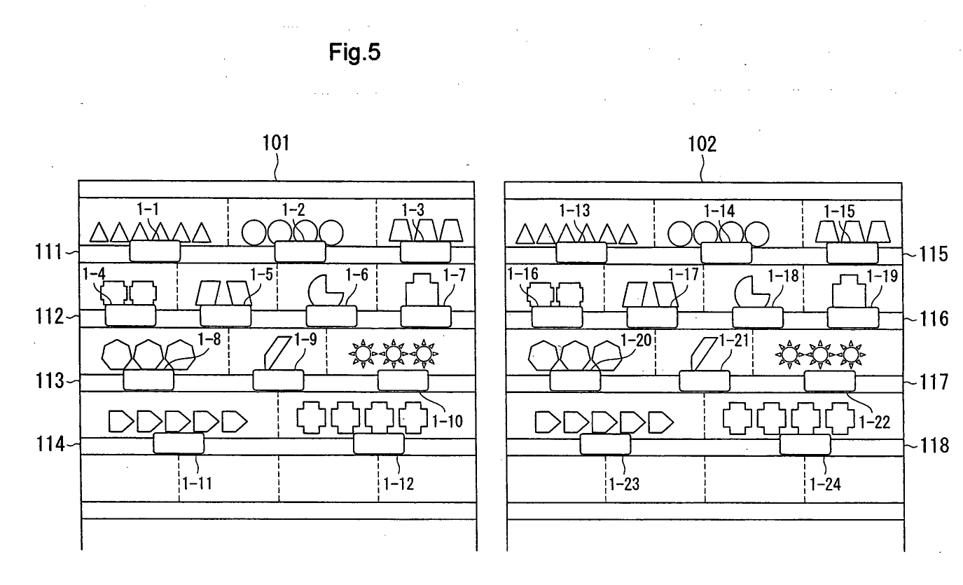

Next, description is given of shelves on which the electronic shelf label terminals 1 are installed. FIG. 5 is a schematic diagram illustrating outer appearances of the shelves on which the electronic shelf label terminals 1 are installed according to this embodiment. In the example illustrated in FIG. 5, a shelf 101 and a shelf 102 are illustrated.

The shelf 101 includes, in order from top, shelf boards 111 to 114 on which products are to be arranged. On the shelf board 111, electronic shelf label terminals 1-1 to 1-3 are installed in order from left. Further, on the shelf board 112, electronic shelf label terminals 1-4 to 1-7 are installed in order from left. Further, on the shelf board 113, electronic shelf label terminals 1-8 to 1-10 are installed in order from left. Further, on the shelf board 114, electronic shelf label terminals 1-11 and 1-12 are installed in order from left.

The shelf 102 includes, in order from top, shelf boards 115 to 118 on which products are to be arranged. On the shelf board 115, electronic shelf label terminals 1-13 to 1-15 are installed in order from left. Further, on the shelf board 116, electronic shelf label terminals 1-16 to 1-19 are installed in order from left. Further, on the shelf board 117, electronic shelf label terminals 1-20 to 1-22 are installed in order from left. Further, on the shelf board 118, electronic shelf label terminals 1-23 and 1-24 are installed in order from left.

Here, it is assumed that a product shelf number of the shelf 101 is “101”. Further, it is assumed that a product shelf number of the shelf 102 is “102”. Further, assuming that information for identifying the shelf boards 111 to 118 is represented by “rows (vertical direction)”, and the rows are assigned numbers in order from top, starting from a number “1”. Specifically, a row of the shelf boards 111 and 115 is represented by “1”. Further, a row of the shelf boards 112 and 116 is represented by “2”. Further, a row of the shelf boards 113 and 117 is represented by “3”. Further, a row of the shelf boards 114 and 118 is represented by “4”.

Further, positions at which the electronic shelf label terminals 1-1 to 1-24 are installed on each of the shelf boards 111 to 118 are represented by “columns (lateral direction)”, and the columns are assigned numbers in order from left, starting from a number “1”. Specifically, a column of the electronic shelf label terminal 1-1, which is installed on far left of the shelf board 111, is represented by “1”. Further, a column of the electronic shelf label terminal 1-2, which is installed second from left on the shelf board 111, is represented by “2”. In this manner, numbers indicating “columns” are assigned to all the positions at which the electronic shelf label terminals 1-1 to 1-24 are installed.

With this configuration, by using the “product shelf number”, the “row”, and the “column”, it is possible to uniquely identify the positions at which the electronic shelf label terminals 1-1 to 1-24 are installed. For example, the position at which the electronic shelf label terminal 1-1 is installed is uniquely identified by the product shelf number “101”, the row “1”, and the column “1”. Further, the position at which the electronic shelf label terminal 1-21 is installed is uniquely identified by the product shelf number “102”, the row “3”, and the column “2”.

Next, description is given of the management information database stored in the management-device storage unit 23 of the ESL server 2. The management information database stores, in association with one another, ESL information indicating information on the electronic shelf label terminal 1, position information indicating a position at which the electronic shelf label terminal 1 is installed, and product information of a product for which the electronic shelf label terminal 1 performs display.

The ESL information is information containing an “ESL code”, a “size”, and a “color”. The position information is information containing the “product shelf number”, the “row (vertical direction)”, and the “column (lateral direction)”. The product information is information containing a “product code”, a “product name”, a “description”, and a “price”.

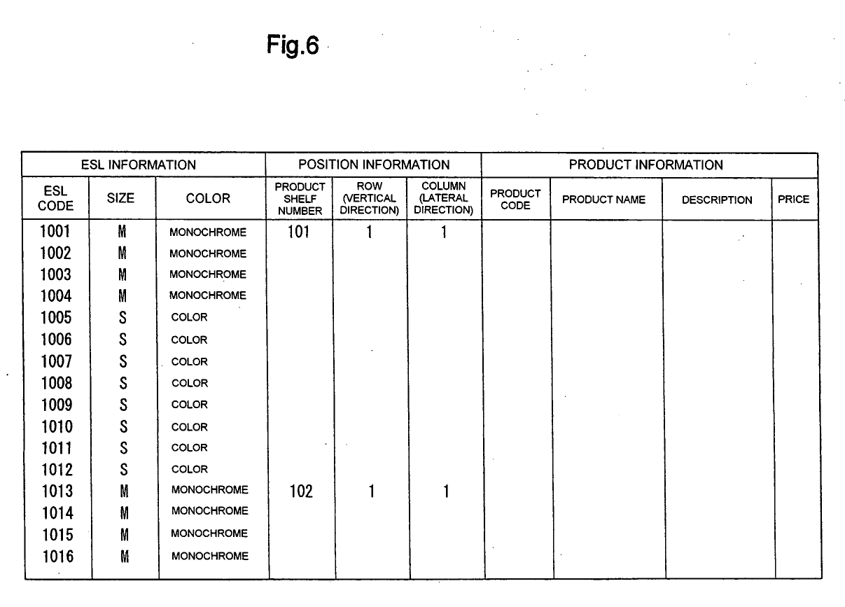

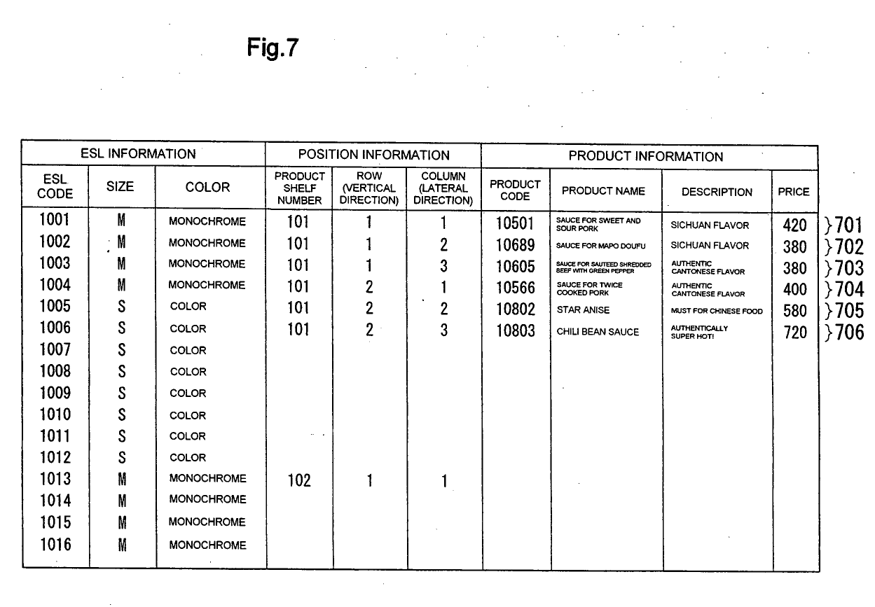

FIGS. 6 and 7 are schematic diagrams illustrating a data structure of the management information database stored in the management-device storage unit 23 of the ESL server 2 according to this embodiment.

The management information database has a data structure in tabular form, and contains data items of the “ESL code”, the “size”, the “color”, the “product shelf number”, the “row (vertical direction)”, the “column (lateral direction)”, the “product code”, the “product name”, the “description”, and the “price”. Further, the management information database stores pieces of information of the respective data items in association with one another on a row basis.

The “ESL code” is an identifier for uniquely identifying the electronic shelf label terminal 1 included in the electronic shelf label system. The “size” represents information indicating a size of the electronic shelf label terminal 1. Specifically, a size “S” indicates that the size of the electronic shelf label terminal 1 is small. Further, a size “M” indicates that the size of the electronic shelf label terminal 1 is medium.

The “color” represents information indicating a color that may be displayed by the display unit 12 included in the electronic shelf label terminal 1. Specifically, “color” indicates that the display unit 12 included in the electronic shelf label terminal 1 is capable of color display. Further, “monochrome” indicates that the display unit 12 included in the electronic shelf label terminal 1 is capable of monochrome display.

The “product shelf number” is an identifier for uniquely identifying a shelf on which the electronic shelf label terminal is installed. The “row (vertical direction)” represents information for identifying a position of a shelf board (vertical position). The “row (vertical direction)” indicates a position numbered in order from top with the topmost shelf board represented by “1”. Details thereof are as illustrated in FIG. 5, and the row (vertical direction) “1” indicates the position of the topmost shelf board of the shelf. Further, the row (vertical direction) “2” indicates the position of the second shelf board from the top of the shelf. Other rows (vertical direction) indicate positions of shelf boards in a similar manner.

The “column (lateral direction)” represents information for identifying a position of a column of the shelf (horizontal position). The column position indicates a position numbered in order from left with the far left column of the shelf represented by “1”. Details thereof are as illustrated in FIG. 5, and the column (lateral direction) “1” indicates the position of the far left column of the shelf. Further, the column (lateral direction) “2” indicates the position of the second column from the left on the shelf. Other columns (lateral direction) indicate positions of columns from the left in a similar manner.

It should be noted that the “product shelf number”, the “row (vertical direction)”, and the “column (lateral direction)” are stored in association with one another, and that the position at which the electronic shelf label terminal 1 is installed is identified by those three pieces of information.

The “product code” is an identifier for uniquely identifying a kind of a product. The “product name” indicates a name of the product. The “description” is text describing the product. The “price” indicates a price of the product. It should be noted that the “product code” is associated with the “product name”, the “description”, and the “price”, and hence when the “product code” is uniquely identified, the “product name”, the “description”, and the “price” are uniquely identified.

FIG. 6 illustrates an example of the management information database obtained when a position setting mode described later is finished. In the example illustrated in FIG. 6, there are stored position information of an electronic shelf label terminal 1 identified by an ESL code 1001 and position information of an electronic shelf label terminal 1 identified by an ESL code 1013. As for the electronic shelf label terminal 1 identified by the ESL code 1001, there is stored information indicating that the electronic shelf label terminal 1 is installed at a position identified by the product shelf number “101”, the row (vertical direction) “1”, and the column (lateral direction) “1”. As for the electronic shelf label terminal 1 identified by the ESL code 1013, there is stored information indicating that the electronic shelf label terminal 1 is installed at a position identified by the product shelf number “102”, the row (vertical direction) “1”, and the column (lateral direction) “1”.

FIG. 7 illustrates an example of the management information database obtained after a product linking mode described later is performed. In the example illustrated in FIG. 7, pieces of the position information and the product information are stored in association with the information display devices 1 identified by ESL codes 1001 to 1006. This shows that associating the position information and the product information with the information display devices 1 identified by the ESL codes 1001 to 1006 has been completed.

Next, description is given of contents shown in each row of the management information database. For example, an example illustrated in a row 701 indicates that the size of the electronic shelf label terminal 1 identified by the ESL code “1001” is “M”, and that the color is “monochrome”.

Further, the electronic shelf label terminal 1 identified by the ESL code “1001” is installed at the position uniquely identified by the product shelf number “101”, the row (vertical direction) “1”, and the column (lateral direction) “1”. Further, it is indicated that the product code of a product for which the electronic shelf label terminal 1 identified by the ESL code “1001” performs display is “10501”, that the product name is “sauce for sweet and sour pork”, that the description is “Sichuan flavor”, and that the price is “420”. Contents shown in the other rows are as illustrated in FIG. 7.

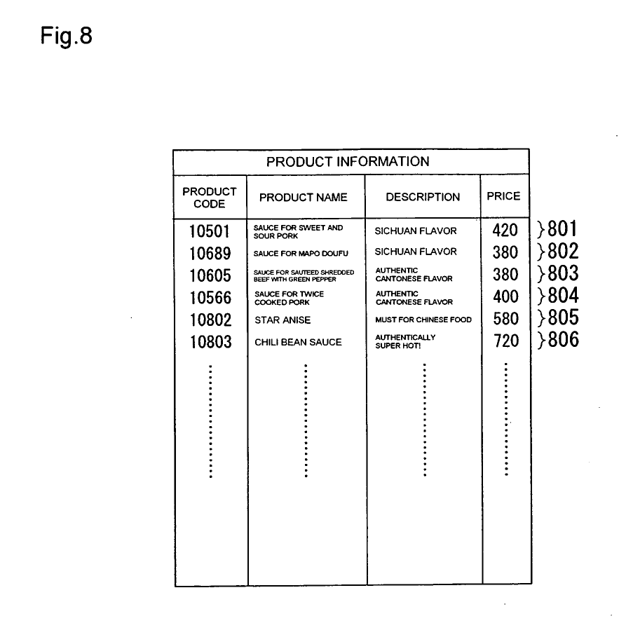

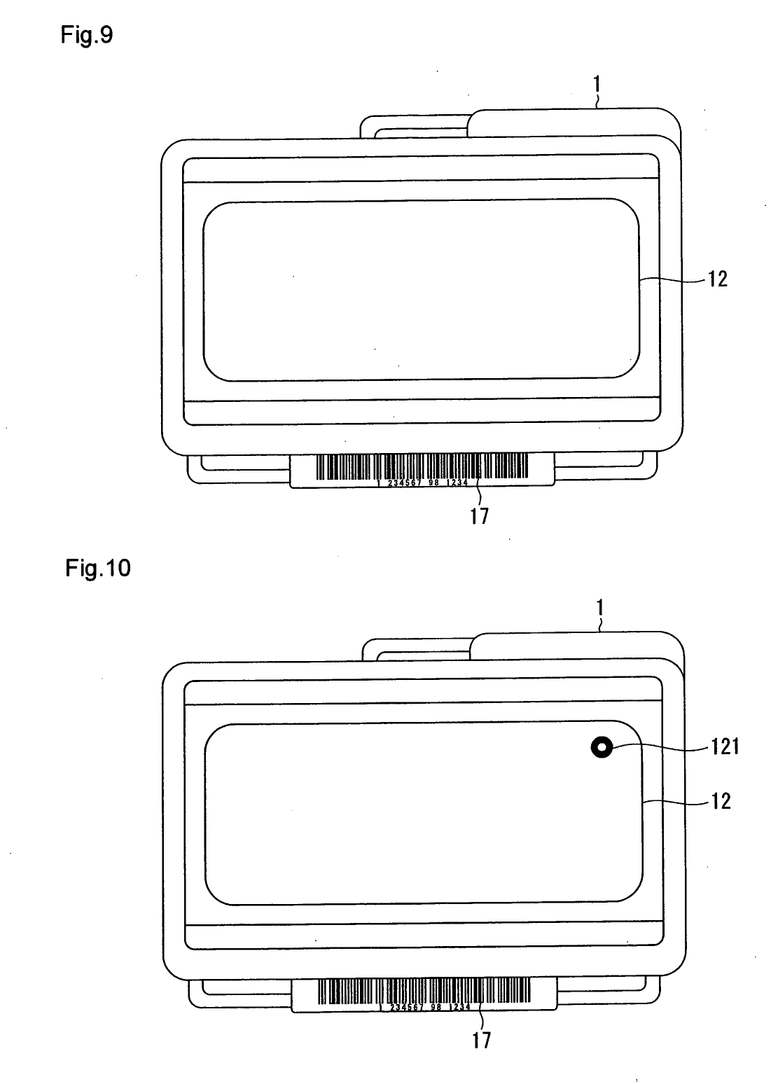

Next, description is given of a product information database stored in the POS server 6. FIG. 8 is a schematic diagram illustrating a data structure of the product information database stored in the POS server 6 according to this embodiment. The product information database has a data structure in tabular form, and contains data items of the “product code”, the “product name”, the “description”, and the “price”. Further, the product information database stores pieces of information of the respective data items in association with one another on a row basis.

The “product code” is an identifier for uniquely identifying a kind of a product. The “product name” indicates a name of the product. The “description” is text describing the product. The “price” indicates a price of the product. It should be noted that the “product code” is associated with the “product name”, the “description”, and the “price”, and hence when the “product code” is uniquely identified, the “product name”, the “description”, and the “price” are uniquely identified.

Next, description is given of contents shown in each row of the product information database. For example, in an example shown in a row 801, it is indicated that the product name of a product identified by the product code “10501” is “sauce for sweet and sour pork”, that the description is “Sichuan flavor”, and that the price is “420”. Contents shown in the other rows are as illustrated in FIG. 8.

Next, with reference to FIGS. 9 to 12, description is given of an example of a screen displayed on the display unit 12 of the electronic shelf label terminal 1. As a method used by the display unit 12 of the electronic shelf label terminal 1 to display a screen, there is a method in which the ESL server 2 creates image data for displaying images illustrated in FIGS. 9 to 12 and transmits the image data to the electronic shelf label terminal 1, and then the display unit 12 of the electronic shelf label terminal 1 displays the images based on the transmitted image data. It should be noted that the method used by the display unit 12 of the electronic shelf label terminal 1 to display a screen is not limited to this method, and any method may be used. For example, the following method may be used. That is, the ESL server 2 transmits various types of information contained in the screens illustrated in FIGS. 9 to 12 to the electronic shelf label terminal 1, and the control unit 11 of the electronic shelf label terminal 1 creates, based on the transmitted information, image data for displaying the images containing a product name, etc. illustrated in FIGS. 9 to 12. Then, the display unit 12 displays the images based on the image data.

FIG. 9 is a schematic diagram for a case where nothing is displayed on the display unit 12 of the electronic shelf label terminal 1 according to this embodiment. On the front of the electronic shelf label terminal 1, the display unit 12 and a barcode 17 are provided. The barcode 17 is a barcode indicating the ESL code of the electronic shelf label terminal 1. In the example illustrated in FIG. 9, the display unit 12 of the electronic shelf label terminal 1 displays nothing.

FIG. 10 is a schematic diagram illustrating a “reference-shelf-label notification screen” displayed on an electronic shelf label terminal 1 that is a reference shelf label serving as a reference for setting position information. In the reference-shelf-label notification screen, a mark 121 indicating that the electronic shelf label terminal 1 is the reference shelf label is displayed in an upper right portion of the screen. In the example illustrated in FIG. 10, the display unit 12 of the electronic shelf label terminal 1 displays a “circle” in the upper right portion of the screen as the mark 121 indicating that the electronic shelf label terminal 1 is the reference shelf label.

FIG. 11 is a schematic diagram illustrating a “reference-shelf-label product-information display screen” displayed on the electronic shelf label terminal 1 serving as the reference shelf label. In the reference-shelf-label product-information display screen, the mark 121 indicating that the electronic shelf label terminal 1 is the reference shelf label is displayed in the upper right portion of the screen, the “product name” is displayed in an upper center of the screen, the “description” is displayed in a center portion of the screen, and the “price” is displayed in a lower portion of the screen.

In the example illustrated in FIG. 11, the display unit 12 of the electronic shelf label terminal 1 displays the “circle” in the upper right portion of the screen, displays “sauce for sweet and sour pork” in the upper center of the screen, displays “Sichuan flavor” in the center portion of the screen, and displays “420 yen” in the lower portion of the screen.

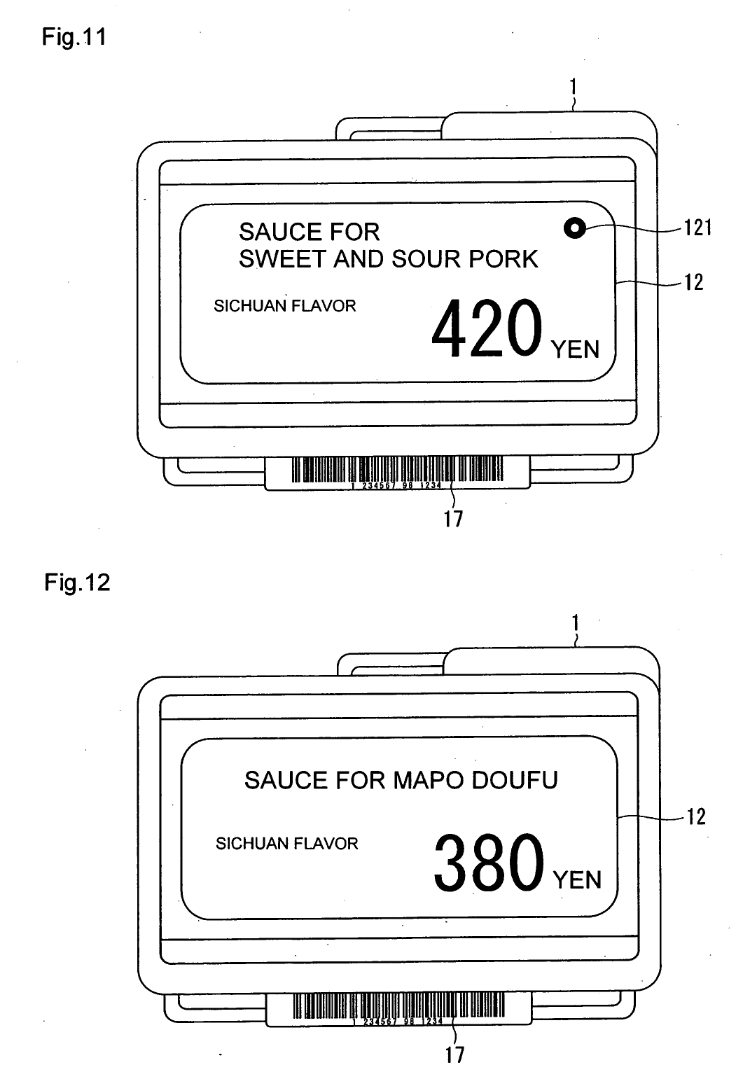

FIG. 12 is a schematic diagram illustrating a “product-information display screen” displayed on the electronic shelf label terminal 1. In the product-information display screen, the “product name” is displayed in an upper center of the screen, the “description” is displayed in a center portion of the screen, and the “price” is displayed in a lower portion of the screen.

In the example illustrated in FIG. 12, the display unit 12 of the electronic shelf label terminal 1 displays “sauce for mapo doufu” in the upper center of the screen, displays “Sichuan flavor” in the center portion of the screen, and displays “380 yen” in the lower portion of the screen.

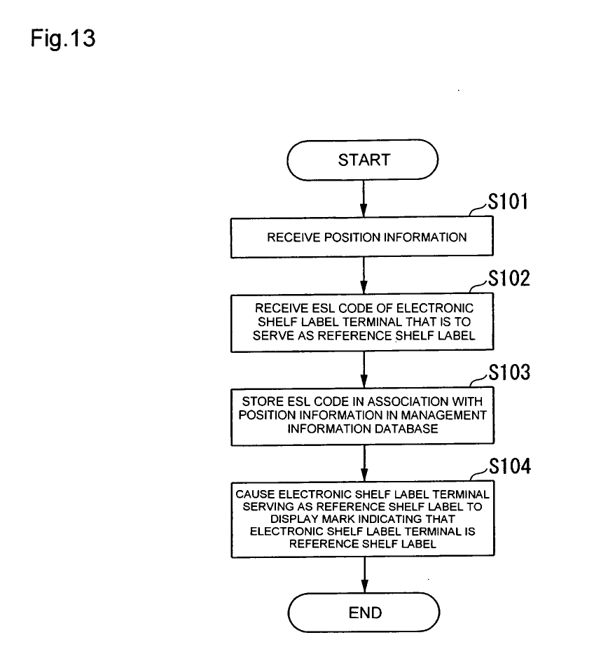

Next, description is given of procedures by which the ESL server 2 sets the position information of the reference shelf label (second information display device) that is to serve as a reference for setting the position information of the electronic shelf label terminal 1 (first information display device). FIG. 13 is a flow chart illustrating operation procedures of the ESL server 2 in the position setting mode, which is an operation mode of setting the position information of the reference shelf label. In this embodiment, for each of the shelves 101 and 102, the following setting processing is performed with the electronic shelf label terminal 1 at the column “1” and the row “1” as the reference shelf label.

(Step S101) An operator uses the input button included in the input unit 56 of the handy terminal 5 to input the position information (information indicating an installation position) regarding a position at which the electronic shelf label terminal 1 that is to serve as the reference shelf label is installed. In the example illustrated in FIG. 5, the electronic shelf label terminal 1-1 is set as the reference shelf label in the shelf 101, and hence the product shelf number “101”, the row “1”, and the column “1” are input as the position information. Further, in the shelf 102, an electronic shelf label terminal 1-13 is set as the reference shelf label. The wireless communication unit 54 of the handy terminal 5 transmits the position information thus input to the ESL server 2. The management-device communication unit 24 of the ESL server 2 receives the position information transmitted from the handy terminal 5. After that, the ESL server 2 proceeds to processing of Step S102.

(Step S102) The operator causes the barcode reader included in the input unit 56 of the handy terminal 5 to read the barcode 17 of the electronic shelf label terminal 1 that is to serve as the reference shelf label. The control unit 51 of the handy terminal acquires the ESL code of the electronic shelf label terminal 1 from the read barcode 17. The wireless communication unit 54 of the handy terminal 5 transmits the acquired ESL code to the ESL server 2. The management-device communication unit 24 of the ESL server 2 receives the ESL code transmitted from the handy terminal 5. After that, the ESL server 2 proceeds to processing of Step S103.

(Step S103) The management-device control unit 21 of the ESL server 2 stores, in association with the position information received in Step S101, the ESL code received in Step S102 in the management information database stored in the management-device storage unit 23. After that, the ESL server 2 proceeds to processing of Step S104. The management information database in this case is, for example, the management information database illustrated in FIG. 6.

(Step S104) The management-device control unit 21 of the ESL server 2 causes the electronic shelf label terminal 1 identified by the ESL code received in Step S102 to display the mark 121 indicating that the electronic shelf label terminal 1 is the reference shelf label. After that, the processing is terminated. At this time, the screen displayed on the electronic shelf label terminal 1 is, for example, the screen illustrated in FIG. 10.

With the above-mentioned procedures, the ESL server 2 may store the position information of the electronic shelf label terminal 1, which serves as the reference, and may also cause the electronic shelf label terminal 1 serving as the reference shelf label to display the mark 121 indicating that the electronic shelf label terminal 1 is the reference shelf label. With this configuration, the operator may determine which electronic shelf label terminal 1 is the reference shelf label by viewing the screens displayed on the electronic shelf label terminals 1.

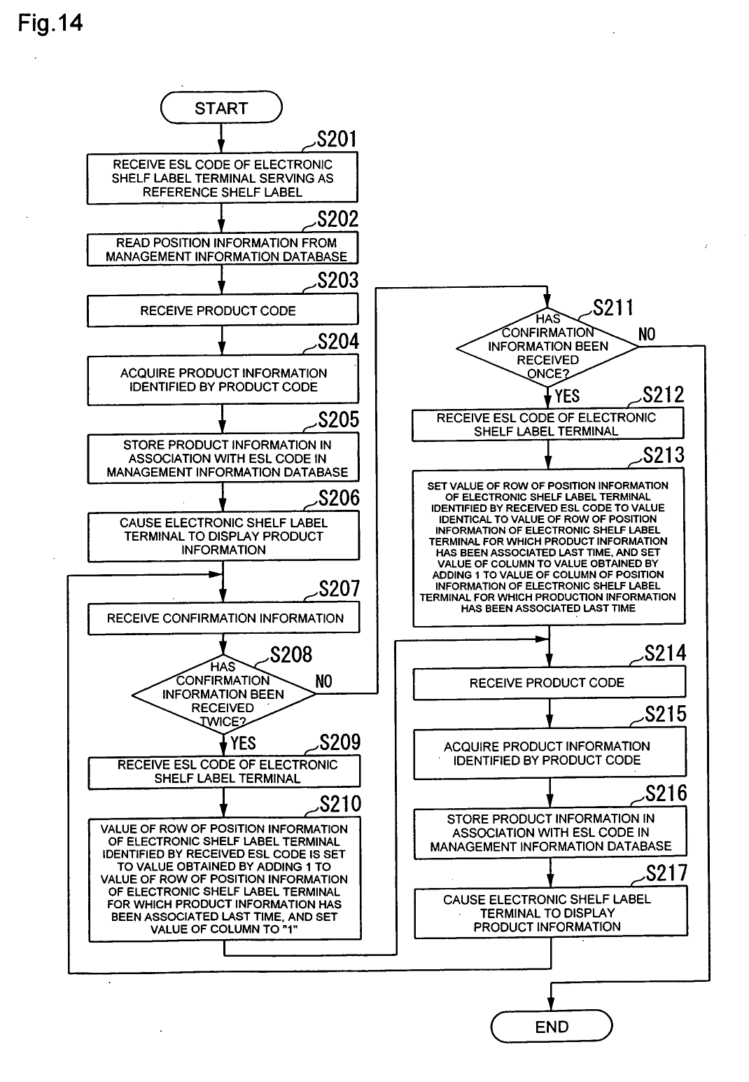

Next, description is given of procedures by which the ESL server 2 stores the position information and the product information in association with the information on the electronic shelf label terminal 1 stored in the management information database. FIG. 14 is a flow chart illustrating operation procedures of the ESL server 2 in the product linking mode, which is an operation mode of storing the position information and the product information in association with the information on the electronic shelf label terminal 1 stored in the management information database.

(Step S201) The operator causes the barcode reader included in the input unit 56 of the handy terminal 5 to read the barcode 17 of the electronic shelf label terminal 1 serving as the reference shelf label. The control unit 51 of the handy terminal 5 acquires the ESL code of the electronic shelf label terminal 1 from the read barcode 17. The wireless communication unit 54 of the handy terminal 5 transmits the acquired ESL code to the ESL server 2. The management-device communication unit 24 of the ESL server 2 receives the ESL code transmitted from the handy terminal 5. After that, the ESL server 2 proceeds to processing of Step S202.

(Step S202) The management-device control unit 21 of the ESL server 2 reads, from the management information database stored in the management-device storage unit 23, the position information stored in association with the ESL code received in Step S201. After that, the ESL server 2 proceeds to processing of Step S203.

(Step S203) The operator causes the barcode reader included in the input unit 56 of the handy terminal 5 to read a barcode attached to a product whose product information is to be displayed on the electronic shelf label terminal 1 from which the barcode has been read in Step S201. It should be noted that the barcode attached to the product is a barcode representing the product code. The control unit 51 of the handy terminal 5 acquires the product code from the read barcode. The wireless communication unit 54 of the handy terminal 5 transmits the acquired product code to the ESL server 2. The management-device communication unit 24 of the ESL server 2 receives the product code transmitted from the handy terminal 5. After that, the ESL server 2 proceeds to processing of Step S204.

(Step S204) The management-device control unit 21 of the ESL server 2 acquires the product information identified by the product code received in Step S203 from the product information database stored in the POS server 6 via the management-device communication unit 24. After that, the ESL server 2 proceeds to processing of Step S205.

(Step S205) The management-device control unit 21 of the ESL server 2 stores, in the management information database stored in the management-device storage unit 23, the product information acquired in Step S204 in association with the ESL code received in Step S201. After that, the ESL server 2 proceeds to processing of Step S206.

(Step S206) The management-device control unit 21 of the ESL server 2 causes the electronic shelf label terminal 1 identified by the ESL code received in Step S201 to display the mark 121 indicating that the electronic shelf label terminal 1 is the reference shelf label and the product information acquired in Step S204. After that, the ESL server 2 proceeds to processing of Step S207. At this time, the screen displayed on the electronic shelf label terminal 1 is, for example, the screen illustrated in FIG. 11.

(Step S207) The operator uses the input button included in the input unit 56 of the handy terminal 5 to input confirmation information (information indicating relative position). At this time, in a case where the electronic shelf label terminal 1 for which the product information and the position information are to be associated with each other next is installed on a shelf board (row) immediately below the electronic shelf label terminal 1 from which the barcode has been read last time, the operator inputs the confirmation information twice. On the other hand, in a case where the electronic shelf label terminal 1 for which the product information and the position information are to be associated with each other next is installed on the same shelf board as the electronic shelf label terminal 1 from which the barcode has been read last time, the operator inputs the confirmation information once. The wireless communication unit 54 of the handy terminal 5 transmits the confirmation information thus input to the ESL server 2. The management-device communication unit 24 of the ESL server 2 receives the confirmation information transmitted from the handy terminal 5. After that, the ESL server 2 proceeds to processing of Step S208.

(Step S208) The management-device control unit 21 of the ESL server 2 determines whether or not the confirmation information has been received twice in Step S207. The management-device control unit 21 of the ESL server 2 proceeds to processing of Step S209 in the case where it is determined that the confirmation information has been received twice, and otherwise proceeds to processing of Step S211.

(Step S209) The operator causes the barcode reader included in the input unit 56 of the handy terminal 5 to read the barcode 17 of the electronic shelf label terminal 1 for which the product information and the position information are to be associated with each other next. The control unit 51 of the handy terminal 5 acquires the ESL code of the electronic shelf label terminal 1 from the read barcode 17. The wireless communication unit 54 of the handy terminal 5 transmits the acquired ESL code to the ESL server 2. The management-device communication unit 24 of the ESL server 2 receives the ESL code transmitted from the handy terminal 5. After that, the ESL server 2 proceeds to processing of Step S210.

(Step S210) The management-device control unit 21 of the ESL server 2 identifies the position information of the electronic shelf label terminal 1 identified by the ESL code received in Step S209. Specifically, the value of the row of the position information to be identified is set to a value obtained by adding 1 to the value of the row of the electronic shelf label terminal 1 for which the product information has been associated last time, and the value of the column is set to “1”. After that, the ESL server 2 proceeds to processing of Step S214.

(Step S211) The management-device control unit 21 of the ESL server 2 determines whether or not the confirmation information has been received once in Step S207. The management-device control unit 21 of the ESL server 2 proceeds to processing of Step S212 in the case where it is determined that the confirmation information has been received once, and otherwise terminates the processing.

(Step S212) The operator causes the barcode reader included in the input unit 56 of the handy terminal 5 to read the barcode 17 of the electronic shelf label terminal 1 for which the product information and the position information are to be associated with each other next. The control unit 51 of the handy terminal 5 acquires the ESL code of the electronic shelf label terminal 1 from the read barcode 17. The wireless communication unit 54 of the handy terminal 5 transmits the acquired ESL code to the ESL server 2. The management-device communication unit 24 of the ESL server 2 receives the ESL code transmitted from the handy terminal 5. After that, the ESL server 2 proceeds to processing of Step S213.

(Step S213) The management-device control unit 21 of the ESL server 2 identifies the position information of the electronic shelf label terminal 1 identified by the ESL code received in Step S212. Specifically, the value of the row of the position information to be identified is set to a value identical to the value of the row of the electronic shelf label terminal 1 for which the product information has been associated last time, and the value of the column is set to a value obtained by adding 1 to the value of the column of the electronic shelf label terminal 1 for which the product information has been associated last time. After that, the ESL server 2 proceeds to processing of Step S214.

(Step S214) The operator causes the barcode reader included in the input unit 56 of the handy terminal 5 to read a barcode attached to a product whose product information is to be displayed on the electronic shelf label terminal 1 from which the barcode has been read in Step S209 or Step S212. The control unit 51 of the handy terminal 5 acquires the product code from the read barcode. The wireless communication unit 54 of the handy terminal 5 transmits the acquired product code to the ESL server 2. The management-device communication unit 24 of the ESL server 2 receives the product code transmitted from the handy terminal 5. After that, the ESL server 2 proceeds to processing of Step S215.

(Step S215) The management-device control unit 21 of the ESL server 2 acquires the product information identified by the product code received in Step S214 from the product information database stored in the POS server 6 via the management-device communication unit 24. After that, the ESL server 2 proceeds to processing of Step S216.

(Step S216) The management-device control unit 21 of the ESL server 2 stores, in the management information database stored in the management-device storage unit 23, the position information identified in Step S210 or Step S213 and the product information acquired in Step S215 in association with the ESL code received in Step S209 or Step S212. After that, the ESL server 2 proceeds to processing of Step S217.

(Step S217) The management-device control unit 21 of the ESL server 2 causes the electronic shelf label terminal 1 identified by the ESL code received in Step S209 or S212 to display the product information acquired in Step S215. After that, the ESL server 2 returns to the processing of S207. At this time, the screen displayed on the electronic shelf label terminal 1 is, for example, the screen illustrated in FIG. 12.

It should be noted that in a case where the barcode 17 of the reference shelf label serving as the reference of the position information has been read in Step S209 or Step S212, the management-device control unit 21 of the ESL server 2 determines that the processing of the product linking mode has been started in another shelf 101 or 102, and starts the processing from Step S201 again. With this configuration, it is possible to perform the processing of the product linking mode continuously in a plurality of the shelves 101 and 102.

As described above, according to this embodiment, first, the processing of the position setting mode is performed to set the position information of the reference shelf label. Then, by using, as the reference, the position information of the reference shelf label set in the position setting mode, the position information is associated with the electronic shelf label terminal 1 at the same time when the product information is associated with the electronic shelf label terminal 1. Further, in this embodiment, based on the number of times the confirmation information is received, it is determined at which position the electronic shelf label terminal 1 for which the product information and the position information are to be associated with each other next is installed relative to the position at which the electronic shelf label terminal 1 for which the product information and the position information were associated with each other last time is installed (the relative position is determined).

With this configuration, the operator may also associate the position information with the information display device 1 without inputting the position information when the product information is associated with the information display device 1.

Further, in this embodiment, the reference shelf label that is to serve as the reference of the position information is determined in the position setting mode, and, based on the reference shelf label, the position information of another electronic shelf label terminal 1 is determined. Therefore, the present invention is applicable regardless of the place at which the electronic shelf label terminal 1 is installed. For example, the present invention is applicable even in a case where the number of shelf boards of the shelf for the installation of the electronic shelf label terminals 1 has increased or decreased or in a case where the number of electronic shelf label terminals 1 to be installed on one shelf board of the shelf has increased or decreased.

### Second Embodiment

Next, description is given of a second embodiment of the present invention. In this embodiment, the reference shelf label that is to serve as the reference of the position information is set for each of the shelf boards 111 to 118 included in the shelves 101 and 102.

In this embodiment, the reference shelf label is set for each of the shelf boards 111 to 118 included in the shelves 101 and 102, and hence, in the case where the barcode 17 of the reference shelf label has been read, the position at which the electronic shelf label terminal 1 for which association is to be established next is installed is identified based on the position information of the read reference shelf label.

It should be noted that a configuration of a retail store system including an electronic shelf label system according to this embodiment is similar to the configuration of the retail store system including the electronic shelf label system according to the first embodiment. Further, a configuration of an electronic shelf label terminal 1 according to this embodiment is similar to the configuration of the electronic shelf label terminal 1 according to the first embodiment. Further, a configuration of an ESL server 2 according to this embodiment is similar to the configuration of the ESL server 2 according to the first embodiment. Further, a configuration of a handy terminal 5 according to this embodiment is similar to the configuration of the handy terminal 5 according to the first embodiment. Further, outer appearances of shelves 101 and 102 according to this embodiment is similar to the outer appearances of the shelves 101 and 102 according to the first embodiment.

Next, description is given of procedures by which the ESL server 2 sets the position information of the reference shelf label that is to serve as the reference for setting the position information of the electronic shelf label terminal 1. The procedures for setting the position information of the reference shelf label according to this embodiment are similar to the procedures for setting the position information of the reference shelf label according to the first embodiment. It should be noted that, in this embodiment, the electronic shelf label terminals 1-1, 1-4, 1-8, 1-11, 1-13, 1-16, 1-20, and 1-23 installed at the left end of the self boards 111 to 118 included in the shelves 101 and 102 are set as the reference shelf labels.

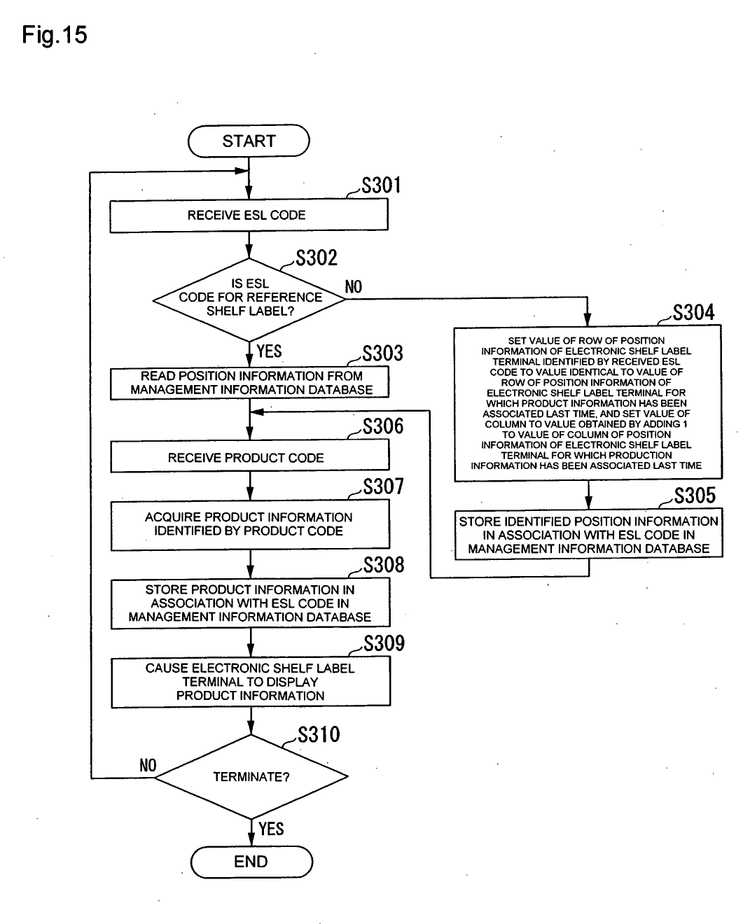

Next, description is given of procedures by which the ESL server 2 stores the position information and the product information in association with the information on the electronic shelf label terminal 1 stored in the management information database. FIG. 15 is a flow chart illustrating operation procedures of the ESL server 2 in a product linking mode according to this embodiment, which is an operation mode of storing the position information and the product information in association with the information on the electronic shelf label terminal 1 stored in the management information database.

(Step S301) The operator causes the barcode reader included in the input unit 56 of the handy terminal 5 to read the barcode 17 of the electronic shelf label terminal 1. The control unit 51 of the handy terminal 5 acquires the ESL code of the electronic shelf label terminal 1 from the read barcode 17. The wireless communication unit 54 of the handy terminal 5 transmits the acquired ESL code to the ESL server 2. The management-device communication unit 24 of the ESL server 2 receives the ESL code transmitted from the handy terminal 5. After that, the ESL server 2 proceeds to processing of Step S302.

(Step S302) Based on the management information database stored in the management-device storage unit 23, the management-device control unit 21 of the ESL server 2 determines whether or not the electronic shelf label terminal 1 identified by the ESL code received in Step S301 is the reference shelf label. For example, in a case where the received ESL code is associated with the position information, the management-device control unit 21 determines that the electronic shelf label terminal 1 is the reference shelf label. In a case where it is determined that the electronic shelf label terminal 1 identified by the ESL code received in Step S301 is the reference shelf label, the management-device control unit 21 of the ESL server 2 proceeds to processing of Step S303, and otherwise proceeds to processing of Step S304.

(Step S303) The management-device control unit 21 of the ESL server 2 reads, from the management information database stored in the management-device storage unit 23, the position information stored in association with the ESL code received in Step S301. After that, the ESL server 2 proceeds to processing of Step S306.

(Step S304) The management-device control unit 21 of the ESL server 2 identifies the position information of the electronic shelf label terminal 1 identified by the ESL code received in Step S301. Specifically, the value of the row of the position information to be identified is set to a value identical to the value of the row of the electronic shelf label terminal 1 for which the product information has been associated last time, and the value of the column is set to a value obtained by adding 1 to the value of the column of the electronic shelf label terminal 1 for which the product information has been associated last time. After that, the ESL server 2 proceeds to processing of Step S305.

(Step S305) The management-device control unit 21 of the ESL server 2 stores, in the management information database stored in the management-device storage unit 23, the position information identified in Step S304 in association with the ESL code received in Step S301. After that, the ESL server 2 proceeds to processing of Step S306.

(Step S306) The operator causes the barcode reader included in the input unit 56 of the handy terminal 5 to read a barcode attached to a product whose product information is to be displayed on the electronic shelf label terminal 1 from which the barcode has been read in Step S301. The control unit 51 of the handy terminal 5 acquires the product code from the read barcode. The wireless communication unit 54 of the handy terminal 5 transmits the acquired product code to the ESL server 2. The management-device communication unit 24 of the ESL server 2 receives the product code transmitted from the handy terminal 5. After that, the ESL server 2 proceeds to processing of Step S307.

(Step S307) The management-device control unit 21 of the ESL server 2 acquires the product information identified by the product code received in Step S306 from the product information database stored in the POS server 6 via the management-device communication unit 24. After that, the ESL server 2 proceeds to processing of Step S308.

(Step S308) The management-device control unit 21 of the ESL server 2 stores, in the management information database stored in the management-device storage unit 23, the product information acquired in Step S307 in association with the ESL code received in Step S301. After that, the ESL server 2 proceeds to processing of Step S309.

(Step S309) The management-device control unit 21 of the ESL server 2 causes the electronic shelf label terminal 1 identified by the ESL code received in Step S301 to display the product information acquired in Step S307. After that, the ESL server 2 returns to the processing of S310.

(Step S310) In a case of terminating the product linking mode, the operator uses the input button included in the input unit 56 of the handy terminal 5 to input an instruction for the termination. In a case where the input unit 56 has received an input giving the instruction for the termination, the wireless communication unit 54 of the handy terminal 5 transmits termination instruction information to the ESL server 2. It should be noted that, if the input unit 56 does not receive an input giving the instruction for the termination, the wireless communication unit 54 of the handy terminal 5 does not perform any processing. In a case where the termination instruction information has been transmitted from the handy terminal 5, the management-device communication unit 24 of the ESL server 2 receives the termination instruction information. The management-device control unit 21 of the ESL server 2 determines whether or not the termination instruction information has been received. In a case where it is determined that the termination instruction information has been received, the management-device control unit 21 of the ESL server 2 terminates the processing, and otherwise returns to the processing of Step S301.

As described above, in this embodiment, the reference shelf label that is to serve as the reference of the position information is set for each of the shelf boards 111 to 118 included in the shelves 101 and 102. Then, in a case where the barcode 17 of the reference shelf label has been read, the position at which the electronic shelf label terminal 1 for which association is to be established next is installed is identified based on the read position information of the reference shelf label. With this configuration, even in a case where the shelf board on which the electronic shelf label terminal 1 for which association is to be established next is installed is different from the shelf board on which the electronic shelf label terminal 1 for which association has been established last time is installed, the confirmation information does not need to be input twice. Accordingly, the operation may be further simplified, and work efficiency may be improved.

### Third Embodiment

Next, description is given of a third embodiment of the present invention. In this embodiment, a barcode indicating the position information is displayed on the electronic shelf label terminal 1 serving as the reference shelf label.

It should be noted that a configuration of a retail store system including an electronic shelf label system according to this embodiment is similar to the configuration of the retail store system including the electronic shelf label system according to the first embodiment. Further, a configuration of an electronic shelf label terminal 1 according to this embodiment is similar to the configuration of the electronic shelf label terminal 1 according to the first embodiment. Further, a configuration of an ESL server 2 according to this embodiment is similar to the configuration of the ESL server 2 according to the first embodiment. Further, a configuration of a handy terminal 5 according to this embodiment is similar to the configuration of the handy terminal 5 according to the first embodiment. Further, outer appearances of shelves 101 and 102 according to this embodiment is similar to the outer appearances of the shelves 101 and 102 according to the first embodiment.

Next, description is given of a management information database stored in the management-device storage unit 23 of the ESL server 2. The management information database according to this embodiment is different from the management information database according to the first embodiment in that the management information database according to this embodiment contains a data item of a “display attribute”.

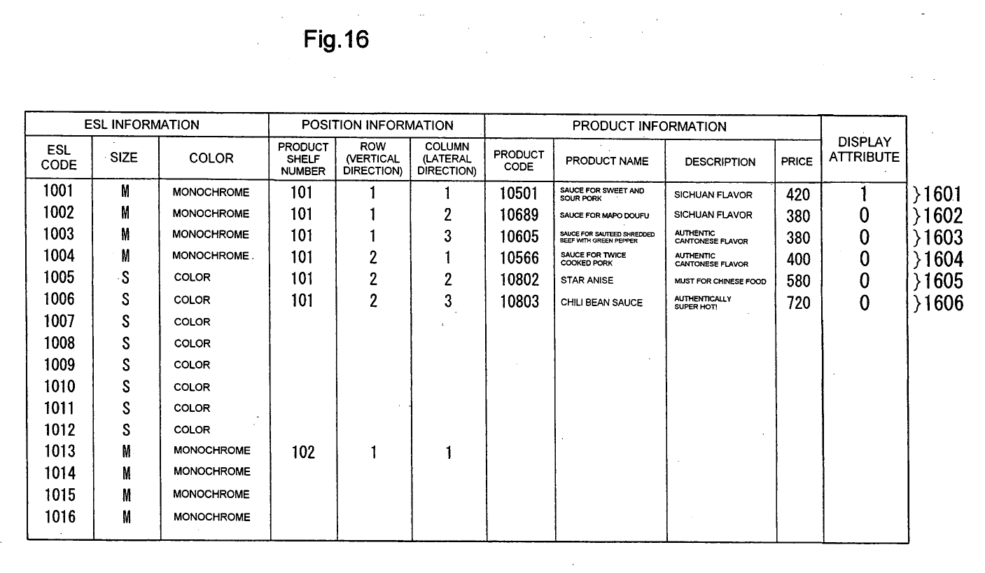

FIG. 16 is a schematic diagram illustrating a data structure of the management information database stored in the management-device storage unit 23 of the ESL server 2 according to this embodiment.

The management information database has a data structure of tabular form, and contains data items of the “ESL code”, the “size”, the “color”, the “product shelf number”, the “row (vertical direction)”, the “column (lateral direction)”, the “product code”, the “product name”, the “description”, the “price”, and the “display attribute”. Further, the management information database stores pieces of information of the respective data items in association with one another on a row basis.

The “display attribute” represents information indicating whether the electronic shelf label terminal 1 is to display the product information or the barcode indicating the position information. Specifically, a display attribute “0” indicates that the electronic shelf label terminal 1 displays the product information. Further, a display attribute “1” indicates that the electronic shelf label terminal 1 displays the barcode indicating the position information.

Next, description is given of contents shown in each row of the management information database. For example, in an example shown in a row 1601, it is indicated that the size of the electronic shelf label terminal 1 identified by the ESL code “1001” is “M”, and that the color is “monochrome”.

Further, the electronic shelf label terminal 1 identified by the ESL code “1001” is installed at a position uniquely identified by the product shelf number “101”, the row (vertical direction) “1”, and the column (lateral direction) “1”. Further, it is indicated that the product code of a product for which the electronic shelf label terminal 1 identified by the ESL code “1001” performs display is “10501”, that the product name is “sauce for sweet and sour pork”, that the description is “Sichuan flavor”, and that the price is “420”.

Further, it is indicated that the electronic shelf label terminal 1 identified by the ESL code “1001” displays the barcode indicating the position information. Contents shown in the other rows are as illustrated in FIG. 16.

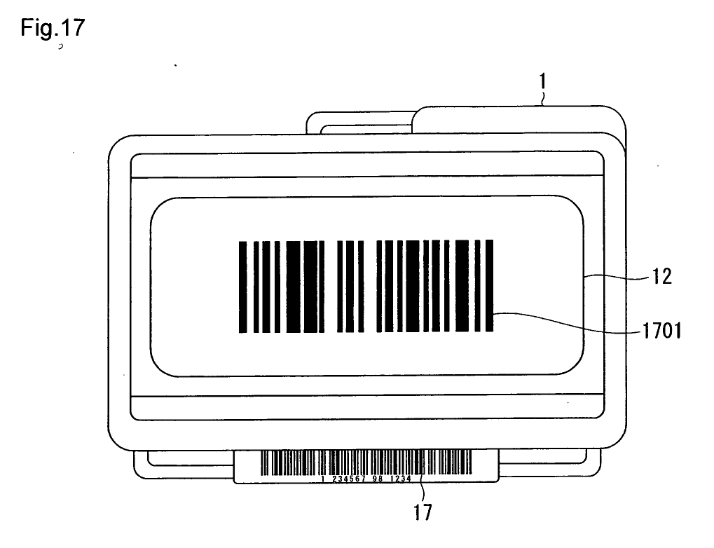

Next, description is given of an example of a screen displayed by the display unit 12 of the electronic shelf label terminal 1 with reference to FIG. 17. FIG. 17 is a schematic diagram illustrating a “position-information-barcode display screen” displayed on the display unit 12 of the electronic shelf label terminal 1 according to this embodiment. In the position-information-barcode display screen, the barcode indicating the position information is displayed in a center portion of the screen. In the example illustrated in FIG. 17, the display unit 12 of the electronic shelf label terminal 1 displays a barcode 1701 indicating the position information in the center portion of the screen.

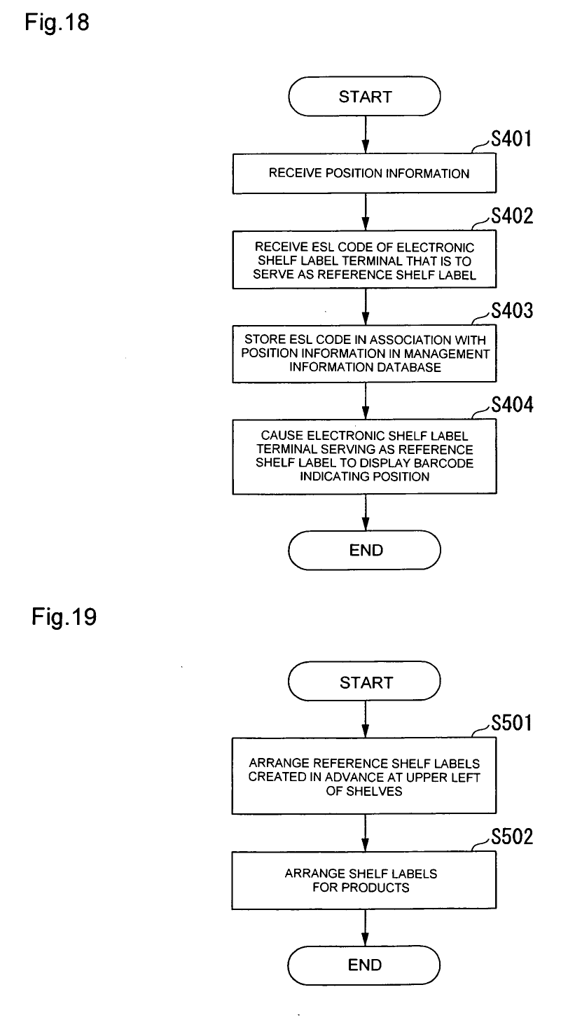

Next, description is given of procedures by which the ESL server 2 sets the position information of the reference shelf label that is to serve as a reference for setting the position information of the electronic shelf label terminal 1, and causes the electronic shelf label terminal 1 serving as the reference shelf label to display the barcode indicating the position information. FIG. 18 is a flow chart illustrating the procedures by which the ESL server 2 sets the position information of the reference shelf label that is to serve as the reference for setting the position information of the electronic shelf label terminal 1, and causes the electronic shelf label terminal 1 serving as the reference shelf label to display the barcode indicating the position information.

(Step S401) The operator uses the input button included in the input unit 56 of the handy terminal 5 to input the position information (information indicating an installation position) regarding a position at which the electronic shelf label terminal 1 that is to serve as the reference shelf label is installed. The wireless communication unit 54 of the handy terminal 5 transmits the position information thus input to the ESL server 2. The management-device communication unit 24 of the ESL server 2 receives the position information transmitted from the handy terminal 5. After that, the ESL server 2 proceeds to processing of Step S402.

(Step S402) The operator causes the barcode reader included in the input unit 56 of the handy terminal 5 to read the barcode 17 of the electronic shelf label terminal 1 that is to serve as the reference shelf label. The control unit 51 of the handy terminal 5 acquires the ESL code of the electronic shelf label terminal 1 from the read barcode 17. The wireless communication unit 54 of the handy terminal 5 transmits the acquired ESL code to the ESL server 2. The management-device communication unit 24 of the ESL server 2 receives the ESL code transmitted from the handy terminal 5. After that, the ESL server 2 proceeds to processing of Step S403.

(Step S403) The management-device control unit 21 of the ESL server 2 stores, in association with the position information received in Step S401, the ESL code received in Step S402 in the management information database stored in the management-device storage unit 23. After that, the ESL server 2 proceeds to processing of Step S404.

(Step S404) The management-device control unit 21 of the ESL server 2 causes the electronic shelf label terminal 1 identified by the ESL code received in Step S402 to display the barcode 1701 indicating the position information. After that, the processing is terminated. At this time, the screen displayed on the electronic shelf label terminal 1 is, for example, the screen illustrated in FIG. 17.

With the above-mentioned procedures, the ESL server 2 may store the position information of the electronic shelf label terminal 1 that is to serve as the reference, and also may cause the electronic shelf label terminal 1 serving as the reference shelf label to display the barcode 1701 indicating the position information. It should be noted that, as the barcode 1701 indicating the position information, any barcode (for example, Code 128 or the like) may be used as long as the barcode is capable of indicating the position information.

Next, description is given of procedures executed when electronic shelf label terminals 1 are arranged in the shelves 101 and 102. FIG. 19 is a flow chart illustrating the procedures executed when the electronic shelf label terminals 1 are arranged in the shelves 101 and 102 according to this embodiment.

(Step S501) The operator arranges the reference shelf labels created in advance through the processing from Step S401 to S404 at the upper left of the shelves 101 and 102. After that, the operator proceeds to processing of Step S502.

(Step S502) The operator arranges shelf labels for products at arbitrary positions in the shelves 101 and 102 in such a manner that those shelf labels correspond to the positions where the products are displayed. After that, the operator terminates the processing.

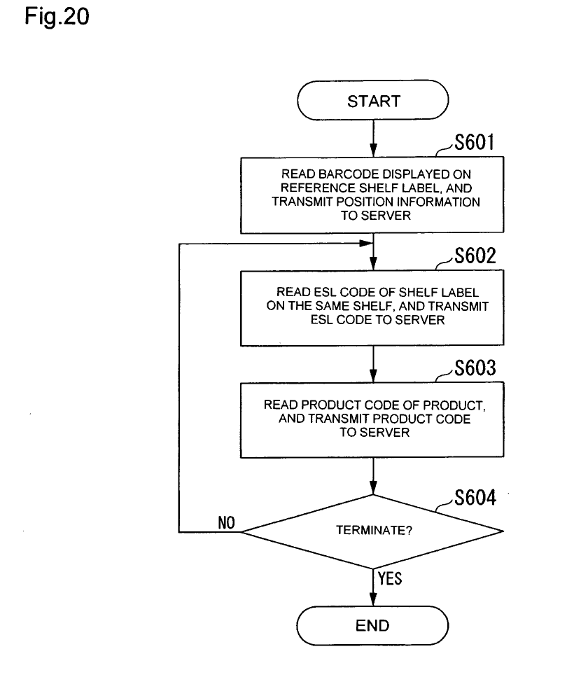

Next, description is given of procedures (procedures for a linking task) by which the ESL server 2 stores the position information and the product information in association with the information on the electronic shelf label terminal 1 stored in the management information database. FIG. 20 is a flow chart illustrating task procedures of the operator which are executed when the position information and the product information are stored in association with the information on the electronic shelf label terminal 1 stored in the management information database according to this embodiment.

(Step S601) After depressing a start key, the operator causes the handy terminal 5 to read the barcode indicating the position information displayed on the electronic shelf label terminal 1 serving as the reference shelf label, and then causes the handy terminal 5 to transmit the position information to the ESL server 2. After that, the operator proceeds to processing of Step S602.

(Step S602) The operator causes the handy terminal 5 to read the barcode 17 of the electronic shelf label terminal 1 installed on the same shelf 101 or 102 as the electronic shelf label terminal 1 serving as the reference shelf label, and then causes the handy terminal 5 to transmit the ESL code to the ESL server 2. After that, the operator proceeds to processing of Step S603.

(Step S603) The operator causes the handy terminal 5 to read a barcode attached to a product that is to be associated with the electronic shelf label terminal 1 from which the barcode 17 has been read in Step S602, and then causes the handy terminal 5 to transmit the product code to the ESL server 2. After that, the operator proceeds to processing of Step S604.

(Step S604) The operator inputs information indicating whether or not to terminate the processing to the handy terminal 5. In a case where the operator has input information indicating that the processing is to be terminated to the handy terminal 5 (for example, in a case where a termination button is depressed), the operator terminates the processing, and otherwise returns to the processing of Step S602.

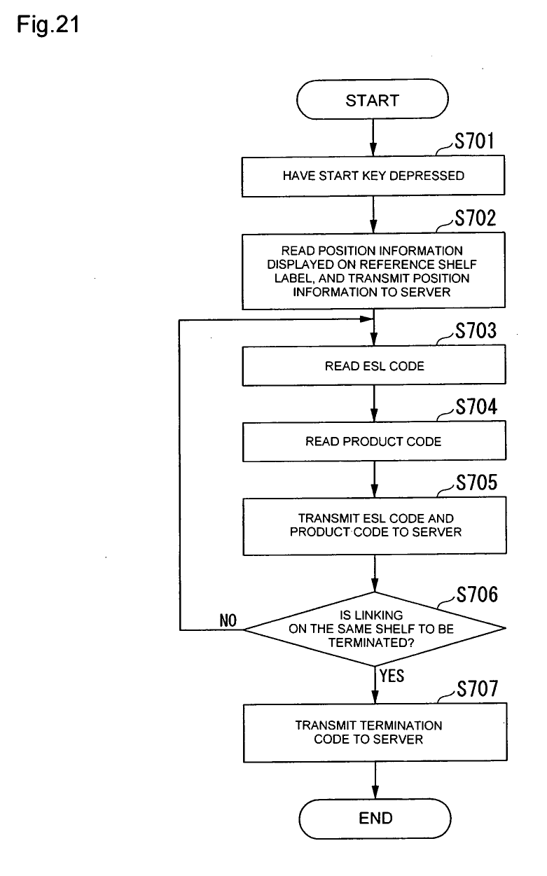

Next, description is given of operation performed by the handy terminal 5 when the ESL server 2 stores the position information and the product information in association with the information on the electronic shelf label terminal 1 stored in the management information database. FIG. 21 is a flow chart illustrating operation procedures executed by the handy terminal 5 when the position information and the product information are stored in association with the information on the electronic shelf label terminal 1 stored in the management information database according to this embodiment.

(Step S701) In a case where the “start key” included in the input unit 56 of the handy terminal 5 has been depressed, the handy terminal 5 proceeds to processing of Step S702.

(Step S702) The barcode reader included in the input unit 56 of the handy terminal 5 reads the barcode 1701 indicating the position information, which is displayed on the electronic shelf label terminal 1 serving as the reference shelf label. The control unit 51 of the handy terminal 5 acquires the position information from the read barcode 1701. The wireless communication unit 54 of the handy terminal 5 transmits the acquired position information to the ESL server 2. After that, the handy terminal 5 proceeds to processing of Step S703.

(Step S703) The barcode reader included in the input unit 56 of the handy terminal 5 reads the barcode 17 of the electronic shelf label terminal 1 installed on the same shelf 101 or 102 as the electronic shelf label terminal 1 serving as the reference shelf label. The control unit 51 of the handy terminal 5 acquires the ESL code of the electronic shelf label terminal 1 from the read barcode 17. After that, the handy terminal 5 proceeds to processing of Step S704.

(Step S704) The barcode reader included in the input unit 56 of the handy terminal 5 reads a barcode attached to a product that is associated with the electronic shelf label terminal 1 from which the barcode 17 has been read in Step S703. The control unit 51 of the handy terminal 5 acquires the product code from the read barcode. After that, the handy terminal 5 proceeds to processing of Step S705.

(Step S705) The wireless communication unit 54 of the handy terminal 5 transmits the ESL code acquired in Step S703 and the product code acquired in Step S704 to the ESL server 2. After that, the handy terminal 5 proceeds to processing of Step S706.

(Step S706) In a case where it is determined that the processing is to be terminated, the control unit 51 of the handy terminal 5 proceeds to processing of Step S707, and otherwise returns to the processing of Step S703. For example, in a case where a “termination key” has been depressed, the control unit 51 of the handy terminal 5 determines to terminate the processing.

(Step S707) The wireless communication unit 54 of the handy terminal 5 transmits a termination code to the ESL server 2. After that, the handy terminal 5 terminates the processing.

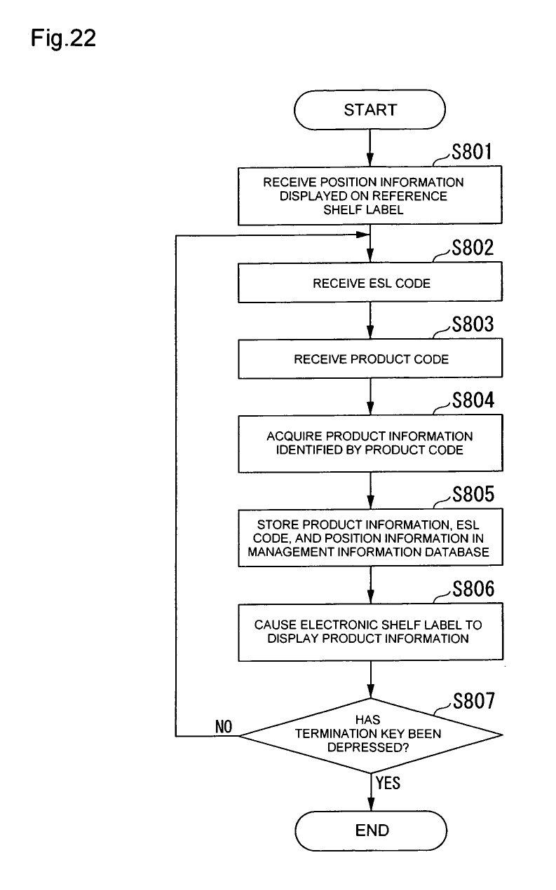

Next, description is given of operation performed by the ESL server 2 when the ESL server 2 stores the position information and the product information in association with the information on the electronic shelf label terminal 1 stored in the management information database. FIG. 22 is a flow chart illustrating operation procedures executed by the ESL server 2 when the position information and the product information are stored in association with the information on the electronic shelf label terminal 1 stored in the management information database according to this embodiment.

(Step S801) The management-device communication unit 24 of the ESL server 2 receives the position information indicating the position at which the electronic shelf label terminal 1 serving as the reference shelf label is installed. After that, the ESL server 2 proceeds to processing of Step S802.

(Step S802) The management-device communication unit 24 of the ESL server 2 receives the ESL code. After that, the ESL server 2 proceeds to processing of Step S803.

(Step S803) The management-device communication unit 24 of the ESL server 2 receives the product code. After that, the ESL server 2 proceeds to processing of Step S804.

(Step S804) The management-device control unit 21 of the ESL server 2 acquires the product information identified by the product code received in Step S803 from the product information database stored in the POS server 6. After that, the ESL server 2 proceeds to processing of Step S805.

(Step S805) Based on the position information received in Step S801, the management-device control unit 21 of the ESL server 2 stores, in the management information database stored in the management-device storage unit 23, the position information indicating the position at which the electronic shelf label terminal 1 identified by the ESL code received in Step S802 is installed, the ESL code received in Step S802, and the product information acquired in Step S804. After that, the ESL server 2 proceeds to processing of Step S806.

(Step S806) Based on the pieces of information stored in the management information database in Step 805, the management-device control unit 21 of the ESL server 2 causes the electronic shelf label terminal 1 identified by the ESL code received in Step S802 to display the product information. After that, the ESL server 2 proceeds to processing of Step S807.

(Step S807) Based on whether or not the management-device communication unit 24 has received the termination code, the management-device control unit 21 of the ESL server 2 determines whether or not the “termination key” included in the input unit 56 of the handy terminal 5 has been depressed. In a case where the management-device communication unit 24 has received the termination code, the management-device control unit 21 of the ESL server 2 determines that the “termination key” included in the input unit 56 of the handy terminal 5 has been depressed. In a case where it is determined that the “termination key” included in the input unit 56 of the handy terminal 5 has been depressed, the management-device control unit 21 of the ESL server 2 terminates the processing, and otherwise returns to the processing of Step S802.

With the above-mentioned procedures, it is possible to cause the electronic shelf label terminal 1 serving as the reference shelf label to display the barcode indicating the position information. Further, even in the case where the electronic shelf label terminal 1 serving as the reference shelf label displays the barcode 1701 indicating the position information, the management-device control unit 21 of the ESL server 2 may associate the product information and the position information with the electronic shelf label terminal 1, and further may cause the electronic shelf label terminal 1 to display the product information.

Further, the above-mentioned processing is performed with respect to all the electronic shelf label terminals 1, and hence pieces of the position information of all the electronic shelf label terminals 1 are stored in the management information database. Thus, even in a case where the display attribute of the electronic shelf label terminal 1 has been changed from “1” to “0”, the position information is not erased but remains in the management information database though the barcode 1701 is not displayed on the display unit 12 of the electronic shelf label terminal 1.

Accordingly, if a method of allowing the display attribute to be changed freely is provided, it is possible to cause the display unit 12 of an arbitrary electronic shelf label terminal 1 to display the barcode 1701 indicating the position information when required.

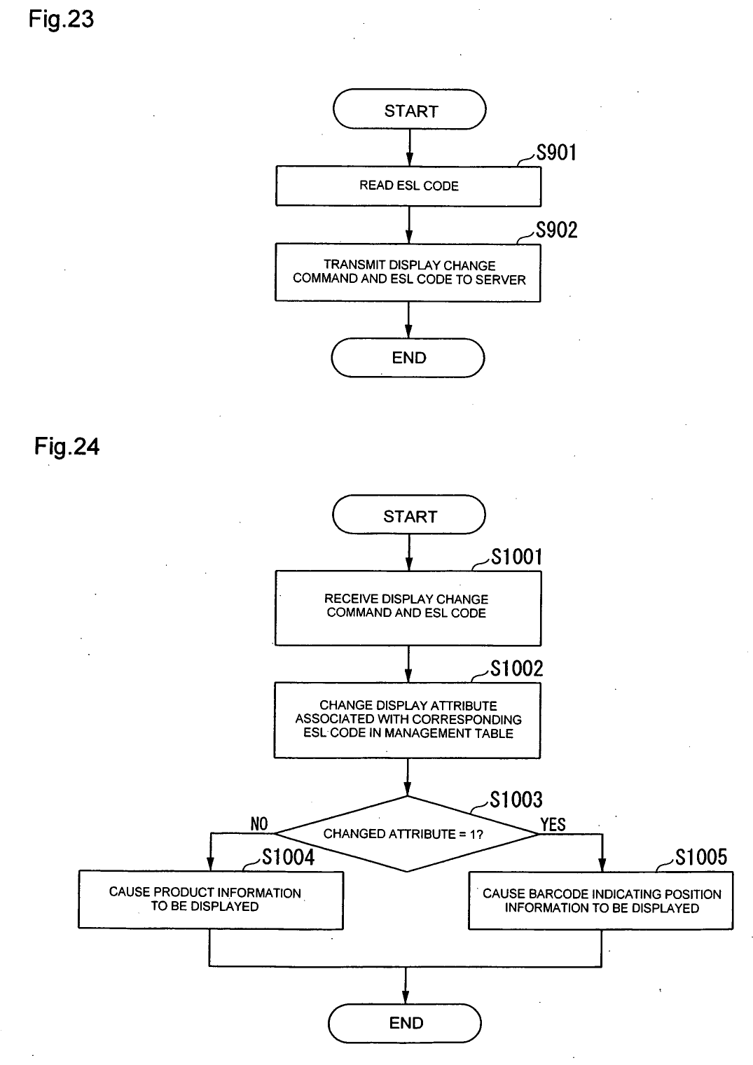

Next, description is given of operation performed by the handy terminal 5 when information displayed on the electronic shelf label terminal 1 is to be changed. FIG. 23 is a flow chart illustrating operation procedures executed by the handy terminal 5 when the information displayed on the electronic shelf label terminal 1 is to be changed according to this embodiment.

(Step S901) The barcode reader included in the input unit 56 of the handy terminal 5 reads the barcode 17 of the electronic shelf label terminal 1. The control unit 51 of the handy terminal 5 acquires the ESL code of the electronic shelf label terminal 1 from the read barcode 17. After that, the handy terminal 5 proceeds to processing of Step S902.

(Step S902) The wireless communication unit 54 of the handy terminal 5 transmits a display change command and the ESL code acquired in Step S901 to the ESL server 2. After that, the handy terminal 5 terminates the processing.

Next, description is given of operation performed by the ESL server 2 when information displayed on the electronic shelf label terminal 1 is to be changed. FIG. 24 is a flow chart illustrating operation procedures executed by the ESL server 2 when the information displayed on the electronic shelf label terminal 1 is to be changed according to this embodiment.

(Step S1001) The management-device communication unit 24 of the ESL server 2 receives the display change command transmitted from the handy terminal 5 and the ESL code. After that, the ESL server 2 proceeds to processing of Step S1002.

(Step S1002) The management-device control unit 21 of the ESL server 2 changes, among the display attributes stored in the management information database, the display attribute associated with the ESL code received in Step S1001. After that, the ESL server 2 proceeds to processing of Step S1003. For example, in a case where the display attribute associated with the ESL code received in Step S1001 is “0”, the management-device control unit 21 of the ESL server 2 changes the display attribute to “1”. Further, in a case where the display attribute associated with the ESL code received in Step S1001 is “1”, the management-device control unit 21 of the ESL server 2 changes the display attribute to “0”.

(Step S1003) The management-device control unit 21 of the ESL server 2 determines whether or not the changed display attribute after the change in Step S1002 is “1”. In a case where it is determined that the changed display attribute is “1”, the management-device control unit 21 of the ESL server 2 proceeds to processing of Step S1005, and otherwise proceeds to processing of Step S1004.

(Step S1004) The management-device control unit 21 of the ESL server 2 causes the electronic shelf label terminal 1 uniquely identified by the ESL code received in Step S1001 to display the product information. After that, the ESL server 2 terminates the processing.

(Step S1005) The management-device control unit 21 of the ESL server 2 causes the electronic shelf label terminal 1 uniquely identified by the ESL code received in Step S1001 to display the barcode 1701 indicating the position information. After that, the ESL server 2 terminates the processing.

With the above-mentioned procedures, it is possible to arbitrarily change a content displayed on the display unit 12 of the electronic shelf label terminal 1 to any one of the product information and the barcode 1701 indicating the position information. Therefore, this enables even the electronic shelf label terminal 1 serving as the reference shelf label to display the product information.

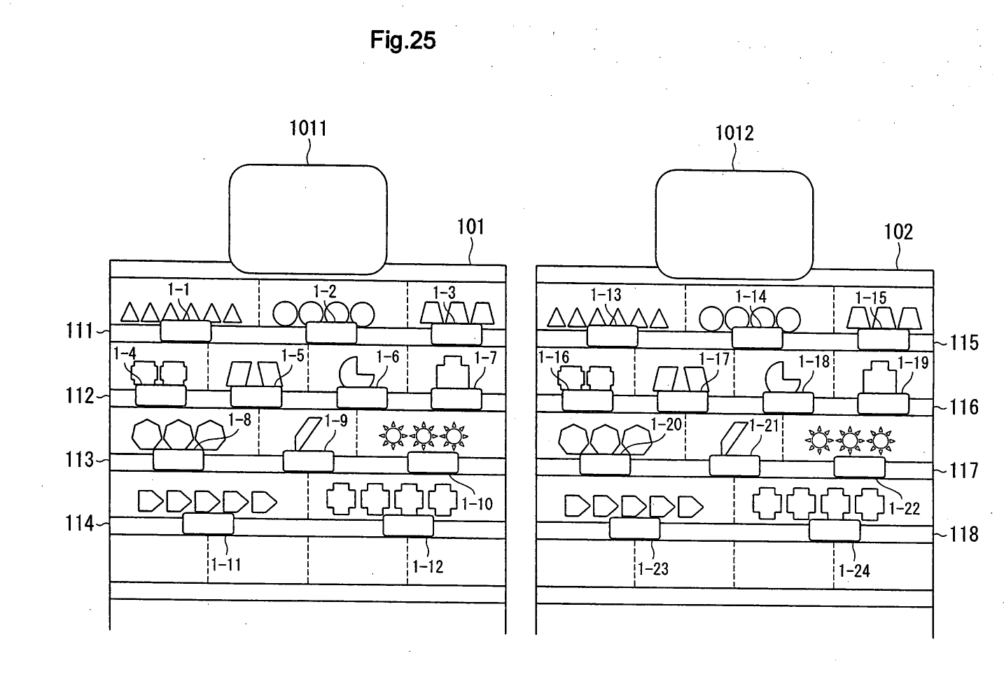

It should be noted that, in the first to third embodiments described above, the electronic shelf label terminal 1 is used as the reference shelf label, but the present invention is not limited thereto. For example, in a case where the electronic shelf label system includes a large-size electronic shelf label device, the large-size electronic shelf label terminal may be used as the reference shelf label. FIG. 25 is an external view illustrating outer appearances of shelves on which large-size electronic shelf label terminals are installed. In the example illustrated in FIG. 25, large-size electronic shelf label terminals 1011 and 1012 are installed in top portions of shelves 101 and 102. It should be noted that outer appearances of other components than the large-size electronic shelf label terminals 1011 and 1012 are similar to the outer appearances illustrated in FIG. 5.

For example, in a case where the large-size electronic shelf label terminals 1011 and 1012 are set as the reference shelf labels, the value of the row of the large-size electronic shelf label terminals 1011 and 1012 is set to “0”, and the values of the columns thereof are set to “1”. With this configuration, the large-size electronic shelf label terminals 1011 and 1012 may be used as the reference shelf labels in the first embodiment and the second embodiment.

Further, the positions at which the electronic shelf label terminals 1 that are to serve as the reference shelf labels are arranged are not limited to the positions of the above-mentioned embodiments. For example, in FIG. 5, the electronic shelf label terminal 1-1 and the electronic shelf label terminal 1-12 may be set as the reference shelf labels. In this case, there exists no electronic shelf label terminal 1 on the right-hand side or the underside of the electronic shelf label terminal 1-12. Accordingly, in a case where the electronic shelf label terminal 1-12 has been read, the processing may be shifted to the shelf 102, assuming that association has been completed for the electronic shelf label terminals 1 installed on the shelf 101.

Further, after all the electronic shelf label terminals 1 have been associated with the product information and the position information, the mark 121 indicating that the electronic shelf label terminal 1 is the reference shelf label, which is displayed on the electronic shelf label terminal 1 serving as the reference shelf label, may be erased. This is because all the electronic shelf label terminals 1 are associated with the position information, allowing the position information of an arbitrary electronic shelf label terminal 1 to be used. Further, after all the electronic shelf label terminals 1 have been associated with the product information and the position information, some electronic shelf label terminals 1 may be removed. This is because the management information database stores the product information and the position information in association with the electronic shelf label terminal 1.

Further, the position information may be any information as long as the position at which the electronic shelf label terminal 1 is installed can be uniquely identified. For example, if the position at which the electronic shelf label terminal 1 is installed may be uniquely identified only by a product shelf number and a shelf board number, the position information may be such information that combines the “product shelf number” and the “shelf board number”. Further, if the position at which the electronic shelf label terminal 1 is installed may be uniquely identified by a floor level number, a code indicating a position on the floor, a code indicating a sales section, and a product shelf number, the position information may be such information that combines the “floor level number”, the “code indicating a position on the floor”, the “code indicating a sales section”, and the “product shelf number”. In this manner, the position information may be changed depending on how a store is managed.

Hereinabove, the embodiments of the present invention have been described in detail with reference to the drawings, and specific configurations are not limited to the embodiments described above. Various modifications in design may be made without departing from the spirit and scope of the present invention.

For example, in the embodiments described above, the description has been given taking as an example the case where the electronic shelf label system is used in retail stores, such as a supermarket and a convenience store, but the present invention is not limited thereto. For example, in a bank or a warehouse, the electronic shelf label terminal may be used as an information display device for displaying various types information. It should be noted that the configuration of the information display device is similar to the configuration of the electronic shelf label terminal 1.

What is claimed is:

1. An information display system, comprising:
a first information display device;
a second information display device;
a management device; and
a handy terminal, wherein:
the handy terminal comprises:
an input unit for receiving an input of information indicating relative position between a position at which the second information display device is installed and a position at which the first information display device is installed, the second information display device serving as a reference for identifying the position at which the first information display device is installed; and
a transmission unit for transmitting, to the management device, information for uniquely identifying the second information display device, information for uniquely identifying the first information display device, and the information indicating the relative position between the position at which the second information display device is installed and the position at which the first information display device is installed; and
the management device comprises:
a management-device storage unit for storing information indicating the position at which the second information display device is installed;
a management-device reception unit for receiving pieces of the information transmitted from the transmission unit of the handy terminal; and
a management-device control unit for identifying the position at which the first information display device is installed based on the information for uniquely identifying the first information display device, the information for uniquely identifying the second information display device, the information indicating the relative position between the position at which the second information display device is installed and the position at which the first information display device is installed, and the information indicating the position at which the second information display device is installed.

2. An information display system according to claim 1, wherein:
the input unit receives an input of information indicating the position of the second information display device;
the transmission unit transmits, to the management device, the information indicating the position of the second information display device; and
the management-device storage unit stores the information indicating the position of the second information display device, which is transmitted from the transmission unit.

3. An information display system according to claim 2, wherein the management-device control unit causes the second information display device to display a barcode indicating information on the position at which the second information display device is installed.

4. An information display system according to claim 3, wherein the first information display device and the second information display device each comprises an electronic shelf label terminal.

5. An information display system according to claim 2, wherein the first information display device and the second information display device each comprises an electronic shelf label terminal.

6. An information display system according to claim 1, wherein the management-device control unit causes the second information display device to display a barcode indicating information on the position at which the second information display device is installed.

7. An information display system according to claim 1, wherein the first information display device and the second information display device each comprises an electronic shelf label terminal.

8. A management device included in an information display system including:
a first information display device;
a second information display device; and
a handy terminal, the management device comprising:
a management-device storage unit for storing information indicating a position at which the second information display device is installed, the second information display device serving as a reference for identifying a position at which the first information display device is installed;
a management-device reception unit for receiving information for uniquely identifying the second information display device, information for uniquely identifying the first information display device, and information indicating relative position between the position at which the second information display device is installed and the position at which the first information display device is installed; and
a management-device control unit for identifying the position at which the first information display device is installed based on the information for uniquely identifying the first information display device, the information for uniquely identifying the second information display device, the information indicating the relative position between the position at which the second information display device is installed and the position at which the first information display device is installed, and the information indicating the position at which the second information display device is installed.

9. A management device according to claim 8, wherein the management-device control unit causes the second information display device to display a barcode indicating information on the position at which the second information display device is installed.
